(19) United States
(12) Patent Application Publication
(10) Pub. No.: US 2007/0162471 A1
(43) Pub. Date: Jul. 12, 2007

(54) Method and an apparatus to provide information to mobile applications

(76) Inventors: Mats Samuelsson, Norfolk, MA (US); Ramneek Bhasin, Cupertino, CA (US); Sanjeev Sardana, Vienna, VA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/329,343

(22) Filed: Jan. 9, 2006

(51) Int. Cl. G06F 7/00

(52) U.S. Cl. 707/100

(57) ABSTRACT

A method and an apparatus to provide information to mobile applications are presented. In one embodiment, the method includes receiving structured objects at a server operated by a first entity from a website operated by a second entity, the structured objects containing information generated from one or more transactions between a user and the second entity at the website. The method may further include storing the structured objects in a designated area of a database coupled to the server, wherein the designated area is associated with the user and allowing the user to access the structured objects stored in the designated area of the database from a mobile device.

### TECHNICAL FIELD

The present invention relates to mobile applications, and more particularly, to providing information to mobile applications.

### BACKGROUND

With the popularization of the Internet, more and more people are conducting their daily transactions online. For example, many people are routinely paying bills online, buying goods and/or services from e-commerce businesses, making reservations, etc. Lots of information is typically generated from these transactions. Currently saving and providing these information to different applications is cumbersome.

In general, information generated from transactions over the Internet is organized and saved in many different kinds of formats and different places. These formats are usually defined for the convenience of the websites from which the information is generated. It is often difficult for users to provide the information to other applications because the formats in which the information is stored or organized in may not be compatible with the other applications.

To further complicate the problem, many people use mobile devices, such as cellular telephones, personal digital assistants, etc., to conduct their transactions online. The storage capacity of many mobile devices is relatively limited, and hence, the mobile devices may easily run out of space for storing the information generated from the transactions. Furthermore, a user may use multiple mobile devices, as well as desktop computers, to conduct their transactions. As a result, information of the user's transactions may be stored on multiple devices. It is troublesome for the user to keep track of the information on each device in order to synchronize the information on all the devices and to avoid overwriting an updated version of the information with an out-of-date version of the information.

### SUMMARY

The present invention includes a method and an apparatus to provide information to mobile applications. In one embodiment, the method includes receiving structured objects at a server operated by a first entity from a website operated by a second entity, the structured objects containing information generated from one or more transactions between a user and the second entity at the website. The method may further include storing the structured objects in a designated area of a database coupled to the server, wherein the designated area is associated with the user and allowing the user to access the structured objects stored in the designated area of the database from a mobile device.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a system to provide user information to mobile applications;

FIG. 2 illustrates one embodiment of a system to collect user information;

FIG. 3 illustrates an alternate embodiment of a system to collect user information;

FIGS. 4A-4C are flow diagrams of one embodiment of a process to collect user information and to provide the collected information to mobile applications; and

FIG. 5 illustrates one embodiment of a virtual wallet.

### DETAILED DESCRIPTION

A method and an apparatus to provide information to mobile applications are described. In the following description, numerous specific details are set forth. However, it is understood that embodiments of the invention may be practiced without these specific details. In other instances, well-known components, structures, and techniques have not been shown in detail in order not to obscure the understanding of this description

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

A method and an apparatus to provide mobile applications with easily accessible information generated from transactions between users and entities that operate websites are presented. Some examples of the information include data associated with a travel reservation (e.g., time, destination, schedule, confirmation, etc.), a purchase order (e.g., product information, shipping information, total amount of order, etc.), and results of a search (e.g., a search performed in a proprietary database, a search over the Internet, etc.). In the following discussion, a mobile application refers to a program or a group of programs executable entirely or in part on a mobile device (such as cellular telephones, personal digital assistants, etc.). The transactions include one or more instances of transmission of information between the users and the websites, which may range from purchases of products/services made by the users on the websites to searches of information requested by the users on the websites.

One advantageous aspect of the approach is the ease of use achieved by integration with the websites or applications associated with the websites. In some embodiments, information is transmitted seamlessly in structured objects (e.g., XML objects) to a database for storage and from which the information is accessible by mobile applications running on a server platform and/or directly by mobile applications. For example, the information may be downloaded to the user's mobile device to be displayed so that the user can retrieve information to review on the go. Note that a database as used in this document may include one or more storage servers and/or storage devices. A structured object is a self-contained entity having a number of parts (e.g., tables, fields, etc.) in which data is organized. The characteristics of these parts (e.g., the type of data that is put into the parts, the size of the parts, etc.) as well as the relationship between the parts are defined by a structured object schema.

In some embodiments, the structured object schema is associated with one or more mobile applications. The structured object schema may include an extensible markup language (XML) schema and a structured object defined according to the XML schema is referred to as an XML object. XML is a pared-down version of Standard Generalized Markup Language (SGML), which is a system for organizing and tagging elements of a document. XML defines a number of tags, which are commands inserted into a document to specify how the document should be formatted. An XML schema uses some or all of these tags to define parts of an XML object. Examples and details of structured objects are discussed below.

In some embodiments, a logical storage device to store some or all of the information generated is implemented by hardware, software, or a combination of both. In one embodiment, the information stored is relatively more complex (e.g., information related to reservations) and hence, the logical storage device is referred to as a virtual briefcase. In an alternate embodiment, the information stored is relatively less complex (e.g., coupons, confirmations, alert information, payment data, etc.), and hence, the logical storage device is referred to as a virtual wallet.

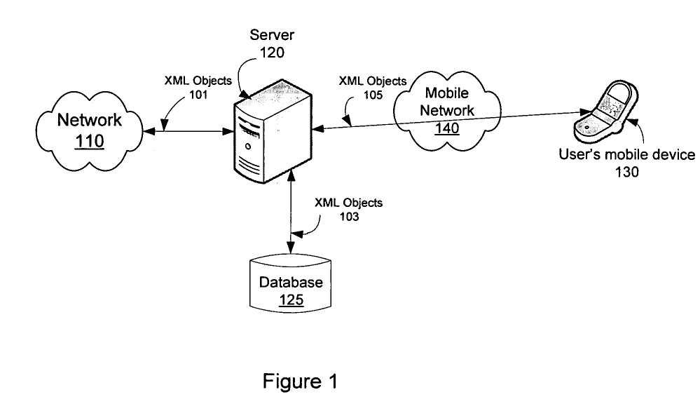

FIG. 1 shows one embodiment of a system. The system 100 includes a network 110, a server 120, a database 125, a mobile network 140, and a mobile device 130. The network 110 is coupled to the server 120 to couple to server 120 to other networks and/or servers (not shown). The network 110 may include a variety of networks, such as, for example, wide area network (e.g., Internet), local area network, etc. Furthermore, the network 110 may include wireless networks, wirelined networks, or a combination of both. The server 120 may include one or more computing devices, which may range from enterprise servers to personal computers. The server 120 is coupled to the database 125. The server 120 stores and retrieves data from the database 125, which may include one or more storage devices (e.g., optical disks, magnetic disks, etc.). Note that the database 125 may be local or remote to the server 120. The server 120 is further coupled to the mobile device 130 via the mobile network 140. The mobile device 130 may be a cellular telephone, a personal digital assistant (PDA), a laptop computer, etc. The mobile network 140 may include wireless networks, wirelined networks, or a combination of both.

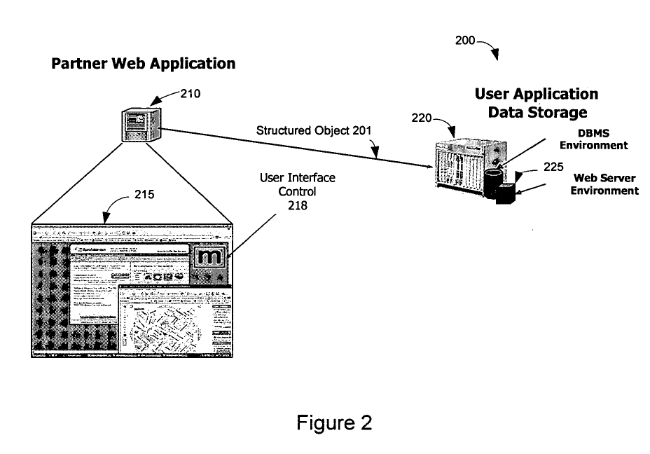

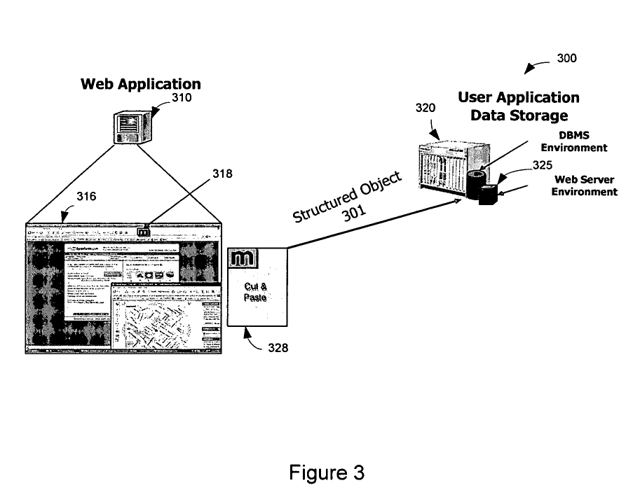

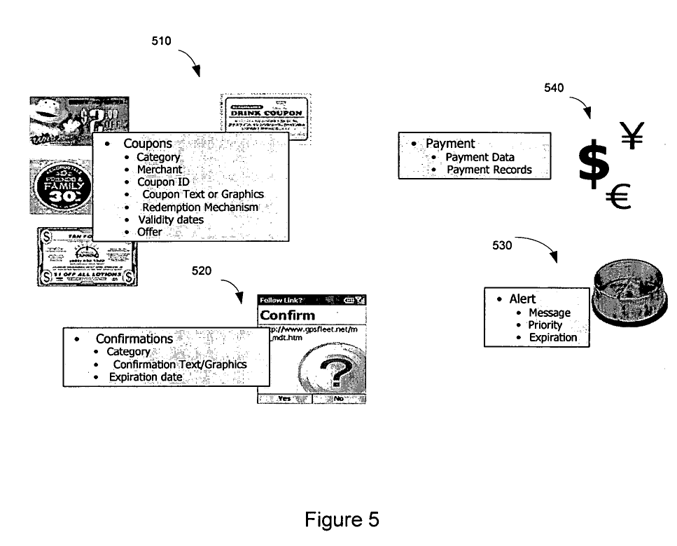

In one embodiment, information related to a user and transactions between the user and one or more third party websites is collected. The information may be collected in various ways and details of some of the exemplary ways are discussed below with reference to FIGS. 2-3. The information is then mapped to one or more structured object schemas, such as an extended markup language (XML) schema, to create structured objects. The structured object schemas are defined based on mobile applications that may use the information collected. A mobile application is a user application operable on a mobile device. Mapping the information to the structured object schema makes it easier for the mobile applications to use the information. Furthermore, the structured objects are associated with the user. For instance, each of the structured objects may include a user identifier (ID) to associate the structured object with the user. Furthermore, the structured objects associated with the user may be used or downloaded by the user, applications invoked by the user, and/or mobile devices associated with the user. Details of some examples of these structured objects are discussed below with reference to FIG. 5. Advantages of the ease of use of the information will be apparent from the discussion of these examples below.

After the information is mapped to the structured object schema to create structured objects 101 (e.g., XML objects), the structured objects 101 are transmitted to the server 120 via the network 110. In some embodiments, the structured objects 101 are pushed to the server 120 such that the server 120 does not have to request the structured objects 101. The server 120 stores the structured objects 103 in an area designated to the user in the database 125. In some embodiments, the structured objects 103 are encrypted to protect the information. The stored structured objects are accessible by the user as well as any third party authorized by the user, such as a vendor providing service to the user. For instance, a mobile application running on the mobile device 130 may request the structured objects 105 from the server 120. The server 120 may retrieve the structured objects 103 from the database 125, decrypt the structured objects 103, and send the structured objects 105 to the mobile device 130 via the mobile network 140.

FIG. 2 illustrates one embodiment of a system to collect user information. The system 200 includes a server 220 and a database 225. The server 220 is further coupled to a web application server 210, which operates a website 215. Note that the server 220 and the web application server 210 are operated by different entities (e.g., internet service vendors, e-commerce businesses, etc.) that partner with each other to provide a seamless way to transfer and store user information related to transactions between the user and the website 215. The system 200 further includes an application that is integrated with the website 215 operated by the partnering entity. The application may integrate a user interface control 218 with the website 215 by creating a user interface control 218 when the website 215 is accessed and displaying the user interface control 218 on the website 215. The user interface control 218 may include an icon, a button, etc.

In one embodiment, information is retrieved or created during one or more transactions conducted between the user and the website 215 via a network access application running on a desktop computer (e.g., a search or a purchase made online via an Internet browser, such as Microsoft Explorer®, Netscape®, etc.). Some or all of the information is put into a structured object according to a structured object schema. The structured object schema may be associated with one or more predetermined mobile applications such that the information in the structured object can be readily accessed and used by the mobile applications.

At the completion of a transaction, the user may be asked if the user wants to store the information generated from the transaction such that the information may be later accessed by some predetermined mobile applications. In some embodiments, a user interface (e.g., a dialog box) may be generated to display such a question to the user. Furthermore, the user interface control 218 may be displayed near the question. When user actuates the user interface control 218, identification information (e.g., a user name and a password) may be requested from the user via, for example, another user interface such as a pop-up window or a dialog box. The user identification may include a user name, the user's phone number, a password, etc. Upon verifying the identification information provided by the user, some or all of the information generated from the transaction may be collected and put into a structured object based on a structured object schema. In one embodiment, the structured object schema includes a variety of tables and/or fields to hold different types of information, such as user identification, user password, application identifier (e.g., travel, entertainment, etc.), date, time, date/time range of information relevance, transaction information (which may further include an extensive schema of information associated with a mobile application), usability and application key information (e.g., alerts, encryption, etc.), etc.

After putting some or all of the information into the structured object, the structured object is sent to the server 220 from the web application server 210. In some embodiments, the structured object is stored in the database 225 accessible only by mobile applications providing the user identification and/or password matching those in the structured object. Furthermore, the information stored may be made available to mobile applications within the range of dates and/or time in the structured object. In some embodiments, the information is made available based on one or more usage parameters in the structured object. Examples of the usage parameters include parameters related to previous use, subscription, multiple use, group uses, etc.

FIG. 3 illustrates an alternate embodiment of a system to collect user information. The system 300 includes a server 320 and a database 325. The system further includes an application for collecting user information. The application may be in a standalone notes mode. Alternatively, the application may be integrated with a browser 316 via which the user access the website. In some embodiments, the application integrated with the browser creates a user interface control 318 (e.g., an icon, a button, etc.) to be displayed on the browser 316.

In some embodiments, a user downloads an application executable by desktop computers to his/her personal computer. The application may be integrated with a network access application, such as an Internet browser. The application downloaded may include one or more programs that extend the capability of a predetermined network access application. In one embodiment, the one or more programs may create an object and have the objected linked to or embedded within the predetermined network access application. For example, the programs may create an icon and embed the icon in a browser-head. To initiate the application, the user may be requested to provide a user identification and/or a password.

The user may conduct one or more transactions over the Internet (e.g., searching over the Internet, buying products/services over the Internet, making reservations over the Internet, etc.). At the completion of a transaction, the user may input some or all of the information generated from the transaction into a user interface generated by the application downloaded. For example, the user interface generated may include a form, a window, a spreadsheet, etc. with blanks for input of information. The user may cut and paste some or all of the information generated from the transaction onto the user interface. This user interface may be associated with a structured object. When the user is done inputting information to the user interface, the user may actuate a user interface control (e.g., a button) to cause a structured object to be created using the information input.

In some embodiment, the structured object is defined according to a structured object schema. This schema may contain a variety of tables and/or fields, such as user ID, password, application identifier (travel, entertainment, etc.), date, time, date/time range of information relevance, transaction information (which may further include an extensive schema of information associated with a mobile application), usability and application key information (e.g., alerts, encryption, etc.), etc.

The structured object created is then transmitted from the user's personal computer to the server 320. Security measures may be taken to protect the information in the structured object during the transmission. For instance, the structured object may be transmitted using Secure Socket Layer (SSL) virtual private network (VPN) tunnel. When the server 320 receives the structured object, the server 320 may store the structured object in the database 325 and make the structured object accessible only by applications associated with the corresponding user ID and/or password in the structured object. Furthermore, the information stored may be made available to mobile applications within the range of dates and/or time in the structured object. In some embodiments, the information is made available based on one or more usage parameters in the structured object. Examples of the usage parameters include parameters related to previous use, subscription, multiple use, group uses, etc.

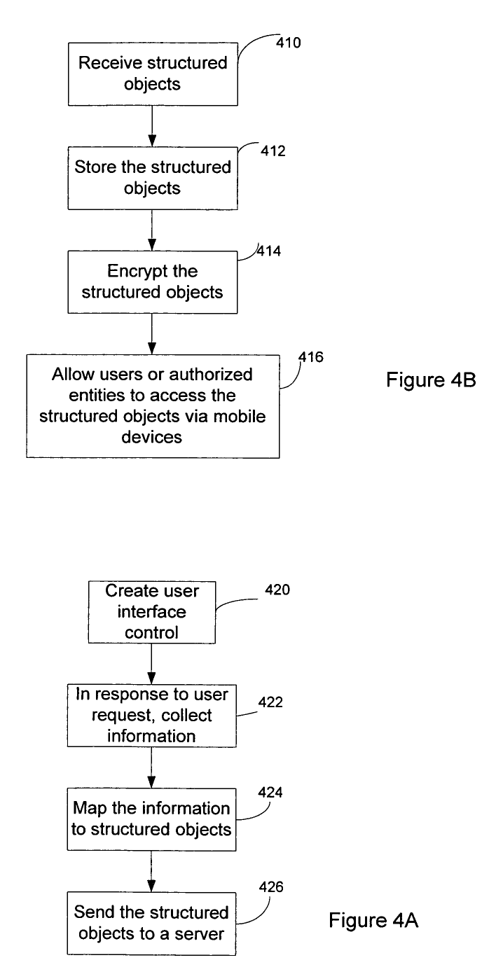

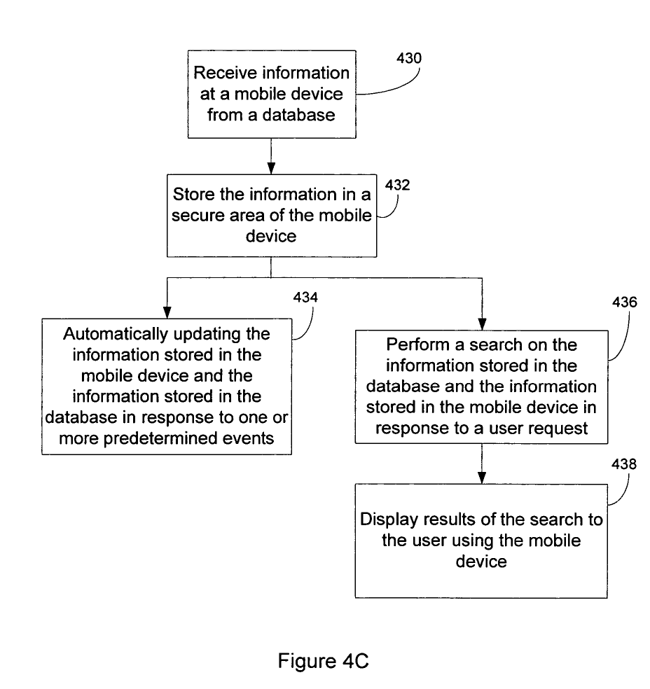

FIGS. 4A-4C illustrate flow diagrams of one embodiment of a process to collect user information and to provide the collected information to mobile applications. The process is performed by processing logic that may comprise hardware (e.g., circuitry, dedicated logic, etc.), software (such as is run on a general-purpose computer system or a dedicated machine), or a combination of both. Furthermore, portions of processing logic may reside on multiple devices. For example, a portion of processing logic may reside over a network (e.g., the Internet) and servers coupled to the network to perform majority of the process and another portion of processing logic may reside on a mobile device to perform minority of the process.

Referring to FIG. 4A, processing logic creates user interface control (e.g., an icon, a button, etc.) (processing block 420). In some embodiments, the user interface control may be integrated with a third party website. For example, an icon may be displayed on the third party website. Alternatively, the user interface control may be integrated with a browser used by the user to access the third party website. For instance, an icon may be displayed on the head of the browser. In another embodiment, the user interface control is generated by a standalone notes application and is displayed separately from the browser.

In response to a user request made using the user interface control, processing logic collect information associated with transactions between a user and a third party website (processing block 422). Processing logic then maps the information to one or more structured object schemas defined based on one or more mobile applications (processing block 424). Mapping the information to the structured object schemas creates one or more structured objects. Processing logic sends the structured objects to a server (processing block 426).

Referring to FIG. 4B, processing logic receives at the server the structured objects containing information associated with transactions between the user and the third party website (processing block 410). In some embodiments, the structured objects include XML objects. Processing logic stores the structured objects in an area designated to the user in a database (processing block 412). To protect the information, processing logic may encrypt the structured objects (processing block 414). Processing logic allows the user to access the structured objects via mobile devices, such as cellular phones, PDAs, etc., or user authorized entities (e.g., e-commerce businesses, service vendors, etc.) to access all or part of the information according to predetermined specifications (processing block 416).

Referring to FIG. 4C, processing logic receives information at a mobile device used by the user from the database (processing block 430). Processing logic stores the information received in a secure area of the mobile device (processing block 432). Processing logic may perform a variety of tasks on the information stored in the mobile device. For example, processing logic may automatically update the information stored in the mobile device in response to one or more predetermined events (processing block 434). Furthermore, processing logic may also update the corresponding information in the database.

In some embodiments, processing logic performs searches on the information stored in the mobile device in response to a user request (processing block 436). Processing logic may also search the information stored on the database. Processing logic then displays results of the search to the user using the mobile device (processing block 438).

FIG. 5 illustrates one embodiment of a virtual wallet. The virtual wallet is a storage area associated with a user for storing relatively small structured objects (also referred to as “objects”) associated with a mobile application. These objects can be in the form of coupons 510, confirmations created by applications 520, event triggered alerts 530, payment information that the user has entered into his/her virtual wallet 540, etc.

In some embodiments, the objects are encrypted. At least a portion of the objects is stored in a secure area of a database (such as the database 225 in FIG. 2) coupled to a user application server (such as the server 220 in FIG. 2). Furthermore, a portion of the objects may also be stored in a secure area of a mobile application on a mobile device. Information in the objects is partitioned to be stored in the database, the mobile device, or both, for usability, security, and performance.

In some embodiments, the objects in the virtual wallet are associated with the user. For instance, each of the objects may include a user identifier (ID) to associate the object with the user. Furthermore, the objects associated with the user may be used or downloaded by the user, applications invoked by the user, and/or mobile devices associated with the user.

The virtual wallet can be accessed in several different ways. In one embodiment, the virtual wallet is accessed by a mobile application associated with a specific wallet item, like vendor coupon, application confirmation, etc. This access can be on the mobile device, the server, or both. In an alternate embodiment, the virtual wallet is accessed via a wallet viewing application (a.k.a. wallet viewer) running on the mobile device used by a user that needs a specific item at a given time. For instance, the wallet viewer may show a coupon to a vendor or make a payment to the vendor in response to user instruction. Alternatively, the virtual wallet may provide self-triggered alerts based on a schedule or the occurrence of a predetermined event. Information on the schedule or the predetermined event may be provided by the user or collected from websites as described above with reference to FIGS. 2-3.

In some embodiments, the user uses a mobile application on a mobile device to perform a task, such as reservation, transaction, participation in a promotion, making payments, etc. The mobile application interacts with the virtual wallet during the course of the performance of the function. For example, the mobile application may leave a coupon and/or a confirmation in the virtual wallet. Alternatively, the mobile application may receive payment information from the virtual wallet.

The virtual wallet may include one or more wallet applications to process the information/objects within the virtual wallet. For example, one of the wallet applications may be a wallet viewer usable to search and display objects in the virtual wallet, such as coupons, confirmations, etc. The wallet viewer may also allow the user to review objects in the virtual wallet. The wallet viewer may provide a user interface having the look and feel of a typical web browser so that the user can easily navigate and browse the contents in the virtual wallet. The wallet viewer may further provide a quick find function to allow the user to search for a predetermined category of objects (e.g., confirmation of appointments on today, payments sent within a week, etc.). One of the wallet applications may allow the user to enter payment information.

In some embodiments, the virtual wallet provides a variety of functions. For instance, one of the functions is data storage. When the mobile device receives user information from the server, the virtual wallet may store the information in the mobile device as wallet XML objects. The virtual wallet may further encrypt the information. The wallet XML objects may include coupons, confirmations, alerts, payments, etc.

Another function supported by the virtual wallet is the organization of different types of information using structured objects. The structured objects may include XML objects. Some examples of the structured objects include coupons, confirmations, alerts, and payment. An exemplary coupon may include the following fields: category, merchant, coupon identification, text on the coupon, graphics on the coupon, redemption mechanism, expiration date, and/or details of the offer. An exemplary confirmation may include fields like, for example, category, location, text of the confirmation, date, time, etc. An exemplary alert may include fields like message to be displayed/played, priority, expiration, etc. An exemplary payment may include fields like payment records, amount paid, date payment has been made, due date of payment, etc.

In some embodiments, the virtual wallet provides various functions to allow the user to manage the contents of the virtual wallet. For example, a user interface may be created to allow the user to review the contents of the virtual wallet and to delete wallet XML objects the user no longer wants. In addition, the user interface may include user interface control to allow the user to search the contents of the virtual wallet. Moreover, the user may be allowed to create virtual compartments within the virtual wallet and to organize the wallet XML objects by putting them into different virtual compartments. In some embodiments, the virtual wallet provides Internet access to the user such that the user can access the Internet during the course of managing the contents of the virtual wallet.

Some portions of the above detailed description are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relates to an apparatus for performing the operations described herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The structures for some embodiments of these systems appear from the description above. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A method comprising:
receiving structured objects at a server operated by a first entity from a website operated by a second entity, the structured objects containing information generated from one or more transactions between a user and the second entity at the website;
storing the structured objects in a designated area of a database coupled to the server, wherein the designated area is associated with the user; and
allowing the user to access the structured objects stored in the designated area of the database from a mobile device.

2. The method of claim 1, wherein the information is collected from the website in response to a request made by the user via user interface control integrated with the website.

3. The method of claim 2, wherein the user interface control is incorporated on a webpage of the website.

4. The method of claim 2, wherein the user interface control is incorporated on a network access application via which the user accesses the website.

5. The method of claim 1, wherein the structured objects include at least one extensible markup language (XML) object.

6. The method of claim 1, further comprising:
making the structured objects available to the user from the database for a predetermined period based on a portion of the information.

7. The method of claim 1, further comprising encrypting the structured objects.

8. The method of claim 1, further comprising allowing a user invoked application performed in the server to access the structured objects stored in the designated area of the database.

9. A machine-accessible medium that provides instructions that, if executed by a processor, will cause the processor to perform operations comprising:
in response to a request from a user, collecting information generated from one or more transactions between the user and a first entity in a website operated by the first entity;
mapping the information to a structured object schema to create a structured object; and
sending the structured object to a server operated by a second entity to be stored in a database coupled to the server, wherein the structured object in the database is accessible by the user using a mobile device.

10. The machine-accessible medium of claim 9, wherein the operations further comprise:
creating a user interface control; and
allowing the user to submit the request by actuating the user interface control.

11. The machine-accessible medium of claim 10, wherein the operations further comprise:
integrating the user interface control with the website.

12. The machine-accessible medium of claim 10, wherein the operations further comprise:
generating a form in which the information is mapped to the structured object schema.

13. The machine-accessible medium of claim 12, wherein the operations further comprise:
integrating the user interface control with a network access application via which the user accesses the website.

14. The machine-accessible medium of claim 12, wherein the form is generated by an application independent of a network access application via which the user accesses the website.

15. The machine-accessible medium of claim 9, wherein the operations further comprise:
requesting a user identification and a password from the user in response to the user request; and
verifying the user identification and the password before collecting the information.

16. A method comprising:
receiving information at a mobile device from a database operated by a first entity, wherein the information has been collected from a website operated by a second entity and stored in the database; and
storing the information in a secure storage area in the mobile device.

17. The method of claim 16, wherein the information comprises one or more structured objects, each of the one or more structured objects being associated with a mobile application operable to run on the mobile device.

18. The method of claim 17, wherein the one or more structured objects include an alert to be triggered by a predetermined event.

19. The method of claim 17, wherein the one or more structured objects include one or more confirmations of the one or more transactions.

20. The method of claim 17, wherein the one or more structured objects include one or more payment records of the one or more transactions.

21. The method of claim 16, further comprising:
automatically updating the information stored in the database and the information stored in the mobile device in response to one or more predetermined events.

22. The method of claim 21, wherein the one or more predetermined events include completion of at least one of the one or more transactions.

23. The method of claim 16, further comprising:
performing a search on the information stored in the database and the information stored in the mobile device in response to a request from the user; and
displaying result of the search using the mobile device.
